(19) United States
(12) Patent Application Publication
(10) Pub. No.: US 2006/0212866 A1
(43) Pub. Date: Sep. 21, 2006

(54) System and method for graphically displaying scheduling information

(76) Inventor: Michael S. McKay, Round Rock, TX (US)

Correspondence Address: IBM CORP (YA);C/O YEE & ASSOCIATES PC, P.O. BOX 802333, DALLAS, TX, 75380, US

(21) Appl. No.: 11/044,364

(22) Filed: Jan. 27, 2005

(51) Int. Cl. G06F 9/46

(52) U.S. Cl. 718/100

(57) ABSTRACT

A system and method for generating a schedule for performance of a task and for graphically displaying scheduling information are provided. A graphical user interface is provided through which the values of one or more scheduling parameters may be entered or selected by a user. The user may select individual values for the scheduling parameters or ranges of values for the scheduling parameters to thereby establish sets of values for each of the scheduling parameters. In addition, the user may select a randomize option for instructing a client agent that performs the task to randomly select a value from the set of values selected by the user, to actually use as the value for that scheduling parameter. The values for the scheduling parameters for each of a plurality of tasks/client agents may be graphically depicted with an indication as to which scheduling parameters are associated with randomly selected values.

### BACKGROUND OF THE INVENTION

1. Technical Field

The present invention is generally directed to an improved data processing system. More specifically, the present invention is directed to a system and method for providing a graphical user interface through which scheduling of tasks may be performed and for graphically displaying scheduling information.

2. Description of Related Art

The scheduling of tasks within a distributed data processing environment is an important consideration in the operation of the computer systems within the environment. This is especially true when the tasks involve data collection from client computing devices so that this data may be reported back to a central location. Since such operations tend to be intrusive to the operation of the client computing device and large amounts of data may be transmitted across network connections to the central location, it is important that the data collection operations be scheduled so as to minimize the impact of these operations on the performance of the data processing environment as a whole.

Typically, in order to minimize the affect of such operations on a data processing environment, such data collection operations are scheduled to be performed at times of low load on the data processing environment system resources. That is, the data collection operations are typically scheduled to be performed late at night, on weekends, and other times when the demand on the system resources is its lowest. Thus, the increased performance drain caused by these data collection operations does not result in a detrimental affect to the data processing system.

However, for some data collection operations, it is desirable to perform the data collection during times of normal system resource loads. Moreover, even in systems that schedule such operations at low load times, all of the operations are typically scheduled for a same time. This may result in many system resources being burdened at the same time and large amounts of data being transmitted across network connections. This may cause network congestion that may detrimentally affect the operation of the data processing environment as a whole. This will most likely be the case if such operations are performed during normal load times of the data processing system.

Thus, it would be beneficial to have a system and method for providing a mechanism through which scheduling of tasks at various times is made possible and user friendly. Moreover, it would be beneficial to have a system and method that permits a user to randomize the scheduling of tasks within a user defined range of possible scheduling times. Furthermore, it would be beneficial to have a system and method that provides a display of the schedules for various task performing resources.

### SUMMARY OF THE INVENTION

The present invention provides a system and method for generating a schedule for performance of a task and for graphically displaying scheduling information. With the present invention, a graphical user interface is provided through which the values of one or more scheduling parameters may be entered or selected by a user. The user may select individual values for the scheduling parameters or ranges of values for the scheduling parameters to thereby establish sets of values for each of the scheduling parameters. In addition, the user may select a randomize option for instructing a client agent that performs the task to randomly select a value from the set of values selected by the user, to actually use as the value for that scheduling parameter.

The various values for the various scheduling parameters and the setting of the randomize option for each scheduling parameter may be stored in a scheduling data structure in association with a task or client agent to which the scheduling data structure applies. In addition, the scheduling data structure may be transmitted to the client agent or device performing the task so that the schedule defined by the scheduling data structure may be implemented.

If the schedule data structure includes one or more user selected options to randomize the value for a scheduling parameter, the client agent may select a value from the set of values designated by the user of the graphical user interface of the present invention. This random selection may be performed upon initial implementation of the schedule with the same randomly selected value being used in each subsequent performance of the task until a new schedule is established.

The schedule data structures stored for each of the client agents may be used to generate a graphical display of the values selected for each schedule parameter for each of the client agents. In addition, the graphical display may designate which schedule parameters are associated with randomly selected values.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating a distributed data processing environment in which aspects of the present invention may be implemented;

FIG. 2 is an exemplary block diagram of a server computing device in which aspects of the present invention may be implemented;

FIG. 3 is an exemplary block diagram of a client computing device in which aspects of the present invention may be implemented;

FIG. 4 is an exemplary diagram illustrating the primary operational components of one exemplary embodiment of the present invention;

FIG. 5 is an exemplary diagram of a graphical user interface through which a schedule for a task performing resource may be defined in accordance with one exemplary embodiment of the present invention;

FIG. 6 is an exemplary diagram of a graphical user interface according to one exemplary embodiment of the present invention, in which individual selection of specific time parameters and ranges of time parameter values is depicted;

FIG. 7 is an exemplary diagram of a graphical user interface according to one exemplary embodiment of the present invention in which more than one of the scheduling parameters is selected to be randomized within a user selected range of values;

FIG. 8 is an exemplary diagram of a graphical display of schedules for a plurality of task performing resources in accordance with one exemplary embodiment of the present invention; and

FIG. 9 is a flowchart outlining an exemplary operation of one exemplary embodiment of the present invention when generating a schedule for performance of a task by a client agent.

### DETAILED DESCRIPTION OF THE PREFERRED EMBODIMENTS

The present invention provides a system and method for providing a graphical user interface (GUI) through which a user may establish a schedule for the performance of tasks as well as obtain a graphical display of scheduling information for a plurality of task performing resources. The present invention may be implemented in a stand-alone computing device or in a distributed data processing environment. In a preferred embodiment, the present invention is implemented as part of a scheduler for a distributed data processing environment in which the scheduler schedules the performance of tasks by client agents on client computing devices.

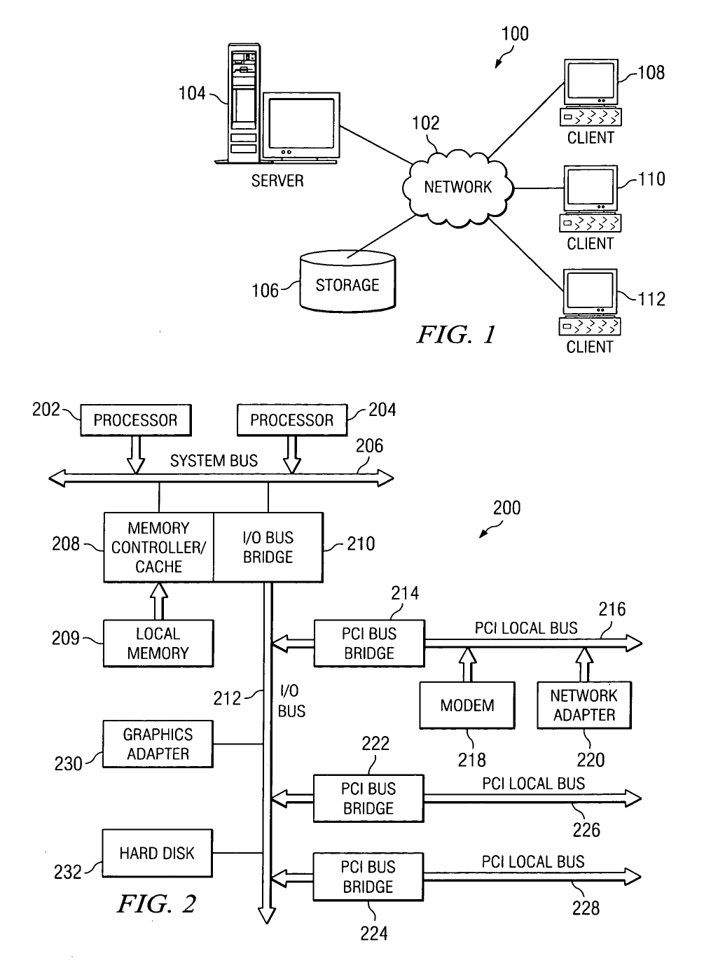

Therefore, the following FIGS. 1-3 are provided as an exemplary environment and exemplary computing devices in which aspects of the present invention may be implemented. It should be appreciated that the environment and devices depicted in FIGS. 1-3 are only exemplary and are not intended to state or imply any limitation as to the configuration or content of the environments and devices in which the aspects of the present invention may be implemented.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

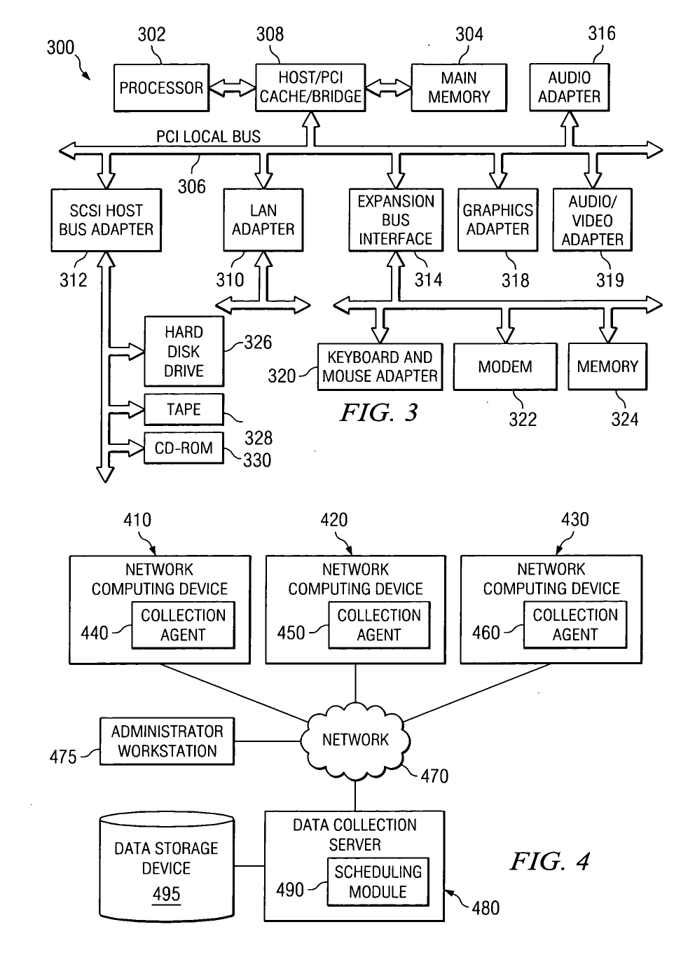

With reference now to FIG. 3, a block diagram illustrating a data processing system is depicted in which the present invention may be implemented. Data processing system 300 is an example of either a stand-alone computing device or a client computer in which aspects of the present invention may be implemented. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As stated above, the present invention provides a mechanism through which a graphical user interface (GUI) is provided to a user for input of scheduling parameters for scheduling the performance of tasks in either a stand-alone computing device or distributed data processing environment. For purposes of the present description, a preferred embodiment of the present invention will be described in terms of a distributed data processing environment in which tasks to be performed by client agents on client computing devices are scheduled by a centralized scheduling mechanism. In particular, a preferred embodiment of the present invention schedules data collection tasks of data collection agents on client computing devices using the GUI and mechanisms of the present invention. However, it should be appreciated that the present invention is not limited to such an embodiment and may be used with the scheduling of any type of task in either a stand-alone computer system or distributed data processing environment.

FIG. 4 is an exemplary diagram illustrating the primary operational components of one exemplary embodiment of the present invention. As shown in FIG. 4, a plurality of network computing devices 410-430 are provided, each having a data collection agent 440-460 associated with them. The data collection agents 440-460 collect various data regarding the state and/or operation of the network computing devices 410-430 with which they are associated and transmit this data back to a data collection server 480 via the network 470. For example, the data collection server 480 may implement a performance monitoring system whose purpose is to monitor the performance of the network computing devices 410 and the system as a whole. The performance monitoring system may require performance data from the network computing devices 410-430 on a periodic basis. This performance data may be collected by the collection agents 440-460 in accordance with a schedule determined by the scheduling module 490.

The scheduling module 490 generates a schedule for each collection agent 440-460 as to when the collection agent 440-460 is to perform its data collection tasks. The schedule may be determined by a user via the administrator workstation 475 by logging onto the data collection server 480 and accessing the scheduling module 490. The scheduling module 490, in accordance with the exemplary aspects of the present invention, provides one or more graphical user interfaces (GUIs) through which the user of the administrator workstation 475 can select or input scheduling parameters for establishing a schedule for one or more of the collection agents 440-460.

These scheduling parameters are stored in a data structure in the data storage device 495 in association with an identifier of the particular collection agent(s) 440-460 for which the schedule data structure applies. In addition, the scheduling data structure is transmitted to the particular collection agent(s) 440-460 to which the scheduling data structure applies so that the collection agent(s) 440-460 may use the scheduling data structure to determine when to perform the next data collection task.

With the GUIs of the present invention, a user is provided the option to enter or select values for various scheduling parameters. In addition, the GUIs permit a user to select a range of values for the various scheduling parameters. Moreover, the GUIs of the present invention permit a user to select whether the actual value for a particular scheduling parameter is randomly selected from a value within the range of values set forth by the user.

For example, in a preferred embodiment of the present invention, the GUIs of the present invention permit a user to identify the days of the month, the days of the week, the hours in the day, and the minutes within the hours that the data collection agent 440-460 is to perform its data collection tasks. Each of these time components are a scheduling parameter whose values may be input or selected by the user. For example, a user may select a first month of the year, a 4^{th} day of the month, a, Mondays of every week, the 11^{th} hour of the day, and the 45^{th} minute of every hour.

Conflicts between selected scheduling parameters may be resolved by providing a warning message to the user indicating which scheduling parameters may have a conflict and informing the user of the likelihood that the schedule will not be executed correctly. For example, if a user selects the first day of the month and also selects Tuesdays of the week, if the first day of the month does not fall on a Tuesday, a conflict may exist. This conflict may be notified to the user so that the user may make appropriate correction to the schedule parameter values to resolve the conflict. Alternatively, if the conflict persists when the schedule is stored and transmitted to the collection agents, conflicts in the schedule may be resolved by not performing the task unless all of the scheduling parameter values are met.

In another embodiment, conflicts may be resolved by prioritizing the scheduling parameters such that conflicts are resolved in favor of the higher priority scheduling parameter involved in the conflict. Thus, for example, if a user selects the first day of the month and Tuesdays of every week, and a conflict arises because the first day of the month is not a Tuesday, the conflict may be resolved in favor of the task being scheduled for the first day of the month (even though it is not a Tuesday) based on a priority of the day of the month being higher than the priority of the day of the week.

In yet another alternative embodiment, the conflict may be resolved in favor of the scheduling parameter that is more restrictive with regard to the schedule. Thus, if every day of the month is selected as a scheduling parameter, and only Sunday is selected as a day of the week scheduling parameter, then the conflict may re resolved in favor of the task being scheduled for every Sunday of the month since this is more restrictive than scheduling the task for every day of the month. Other mechanisms for resolving conflicts between scheduling parameters may be used without departing from the spirit and scope of the present invention.

In addition to setting particular values for the scheduling parameters, the user may set forth a range of values for each of these scheduling parameters. For example, rather than specifying individual months, days of the month, days of the week, hours and minutes, the user may select a range of each of these values. Thus, a user may select months 1-6 of the year, every day of the week, every hour of the day, and the 45^{th} minute of every hour.

Furthermore, the user may select a randomize parameter to be applied to the values or range of values selected for a particular scheduling parameter. This randomize parameter instructs the client agent, e.g., the collection agents 440-460, to randomly select a value for that scheduling parameter from the values or range of values specified by the user when they first implement the schedule set forth in a schedule data structure sent to them by the scheduling module 490. This randomly selected value is then utilized by the client agent until the schedule is again updated by the sending of a new schedule data structure to the client agent.

Thus, by setting the randomize flag associated with a scheduling parameter, a user may designate that a randomly selected value, selected from the values or range or values specified by that user for that scheduling parameter, be used rather than the user having to personally select a value for the schedule. In this way, the user may use the same set of scheduling parameter inputs with a plurality of client agents with each client agent selecting a different actual value to use in the implementation of the schedule.

The values, ranges of values, and randomize flags selected or entered by the user via the GUIs of the present invention are used to generate a schedule data structure associated with one or more of the client agents. The schedule data structure includes the values or range of values selected or entered by the user for each of the scheduling parameters. In association with each of these values or range of values is a randomize bit. The randomize bit is set if the user selected the randomize parameter in association with the particular scheduling parameter. This data structure is stored in a data storage device 495 in association with an identifier of the client agent(s) to which it corresponds. In addition, the scheduling module 490 instructs the data collection server 480 to transmit this scheduling data structure to the appropriate client agents, e.g., collection agents 440-460, with which the scheduling data structure corresponds.

At the network computing devices 410-430, the scheduling data structure is received and provided to the client agents, e.g., collection agents 440-460. The collection agents 440-460 parse the scheduling data structure and determine the schedule of “wake up” times for the client agent. The “wake up” time is the time at which the client agent changes from a waiting state to an active state and performs the tasks associated with that client agent, e.g., data collection. During the parsing of the scheduling data structure, the collection agents 440-460 determine if a randomize bit has been set for the scheduling parameters. If a randomize bit has been set for a scheduling parameter, the client agent randomly selects a value for that scheduling parameter from the set of scheduling parameter values selected by the user. This set of scheduling parameter values may be a set of individual values or a range of values for the scheduling parameter. This process is performed for each scheduling parameter for which the randomized bit is set in the scheduling data structure.

Once the scheduling data structure is parsed and processed, the client agent stores a schedule for waking up the client agent to perform its associated tasks. Thereafter, according to the stored schedule, the client agent periodically wakes up, performs its associated tasks, and transmits the resulting data back to the data collection server 480. In determining when to wake up and perform its tasks, the client agent determines whether the current conditions, e.g., the current timestamp, match the schedule stored by the client agent and, if so, the client agent wakes up. For example, if the schedule designates every day of the month, every day of the week, the 11^{th} hour of the day, and the 45^{th} minute of the hour, then when these conditions are currently present, the client agent wakes up and performs its associated tasks.

The setting of schedules for client agents in accordance with the above description may be performed for a plurality client agents, individual tasks performed by one or more client agents, or the like. Thus, the present invention provides a graphical user interface through which one or more client agents or tasks may have their schedules for performance defined or modified. In addition, the present invention provides a mechanism for displaying the schedules that are generated for each of the client agents in such a manner that they maybe visually compared by a user to see how the client agents of a system are scheduled to perform their tasks. Such a display includes fields for displaying the name of the client agent and graphical depictions of the values selected for each scheduling parameter. In addition, indicators are provided for identifying which scheduling parameters have a randomize parameter associated with them. In this way, the user may quickly determine which client agents are going to be operating at various times in the data processing environment.

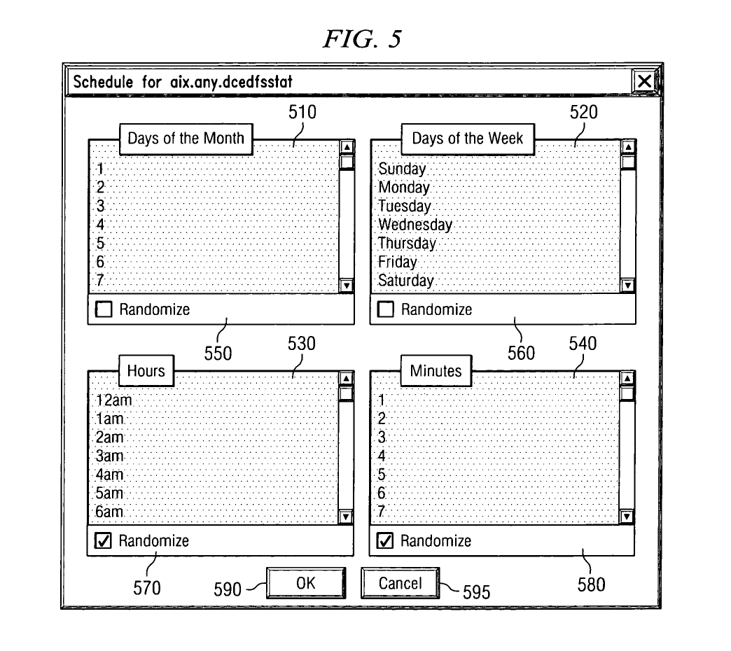

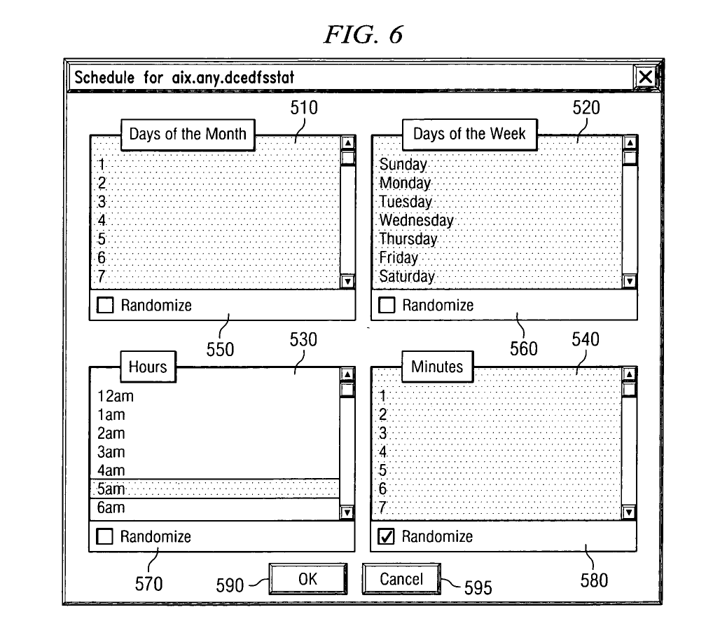

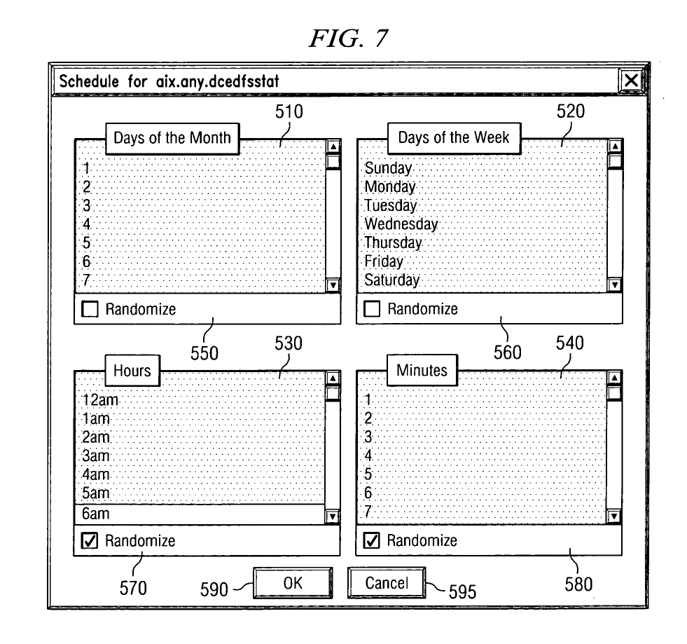

FIG. 5 is an exemplary diagram of a graphical user interface through which a schedule for a task performing resource may be defined in accordance with one exemplary embodiment of the present invention. The graphical user interface (GUI) shown in FIG. 5, and in FIGS. 6-7 described hereafter, illustrates particular scheduling parameters that may be set using the exemplary GUI. These scheduling parameters are only exemplary and are not intended to state or imply any limitation on the types of scheduling parameters that may be utilized with the present invention. In fact, other scheduling parameters may be provided in addition to, or in replacement of, the scheduling parameters depicted in FIGS. 5-7 without departing from the spirit and scope of the present invention.

As shown in FIG. 5, the exemplary graphical user interface includes a first component 510 for selecting days of the month in which a task is to be scheduled to be performed, a second component 520 for selecting days of the week that a task is to be scheduled to be performed, a third component 530 for selecting the hours of the day at which the task is to be scheduled to be performed, and a fourth component 540 for selecting the minutes of the hour at which the task is to be scheduled to be performed. In addition, each of these components 510-540 includes a randomize component 550-580 that may be selected in order to set a randomize bit in association with the scheduling parameter of that particular component 510-540. Two virtual buttons 590 and 595 are also provided for either submitting the selection of scheduling parameters or canceling the selection of scheduling parameters.

In the depicted example, those values in the components 510-540 that are shaded are considered to have been selected by the user as values to be included for the scheduling parameter associated with the components 510-540. The selection of values may be performed, for example, using a pointing device, such as a mouse. The use may position a cursor using the mouse and then select a value by clicking an appropriate button on the mouse to thereby select and highlight (depicted as shading) the value over which the cursor sits.

Thus, in the depicted example, the user has selected every day of the month, every day of the week, every hour of the day and every minute of every hour as the values to be included in the scheduling parameters associated with components 510-540. In addition, the user has selected to randomize the actual value used for components 530 and 540 by selecting the check box of the randomize components 570-580. As a result, the schedule that is generated based on the selections made by the user as illustrating in FIG. 5 is that the task or client agent is scheduled to operate at a randomly selected minute of a randomly selected hour of every day of the month.

This randomly selected minute and hour are selected the first time the client agent implements the schedule and the same randomly selected values are used in subsequent operations of the client agent until a new schedule is established. Thus, if upon initial implantation, the client agent selects the 45^{th} minute of the 11^{th} hour of the day, the client agent will operate at this same minute and hour for every day of the month. A different randomly selected minute and hour of the day is not selected for each day of the month.

However, in an alternative embodiment, the randomly selected values may be periodically changed such that a different randomly selected value is utilized. Thus, for example, rather than using the same minute of the same hour for every day of the month, the present invention may update the randomly selected minute and hour every day, every week, every two weeks, etc., so that a different minute and hour are randomly selected periodically.

FIG. 6 is an exemplary diagram of a graphical user interface according to one exemplary embodiment of the present invention, in which individual selection of specific time parameters and ranges of time parameter values is depicted. As shown in FIG. 6, rather than selecting every hour of the day in component 530, a particular hour of the day is selected, i.e. 5 a.m. Thus, the schedule that is implemented as a result of the selections shown in FIG. 6 is that the client agent wakes up at a random minute within the hour spanning 5 a.m. to 6 a.m. every day of the month. Again, this randomly selected minute may be initially set when the schedule is first implemented by the client agent or may be periodically updated with a newly randomly selected value, as described previously with regard to FIG. 5.

FIG. 7 is an exemplary diagram of a graphical user interface according to one exemplary embodiment of the present invention in which more than one of the scheduling parameters is selected to be randomized within a user selected range of values. As shown in FIG. 7, a subset of the possible values for the hours of the day in component 530 are selected. In addition, the randomize component 570 is selected. Thus, the resulting schedule from the user inputs depicted in FIG. 7 is that the client agent will wake up at a random minute of a random hour of the day selected from the range of times 12 a.m. to 5 a.m. or every day of the month.

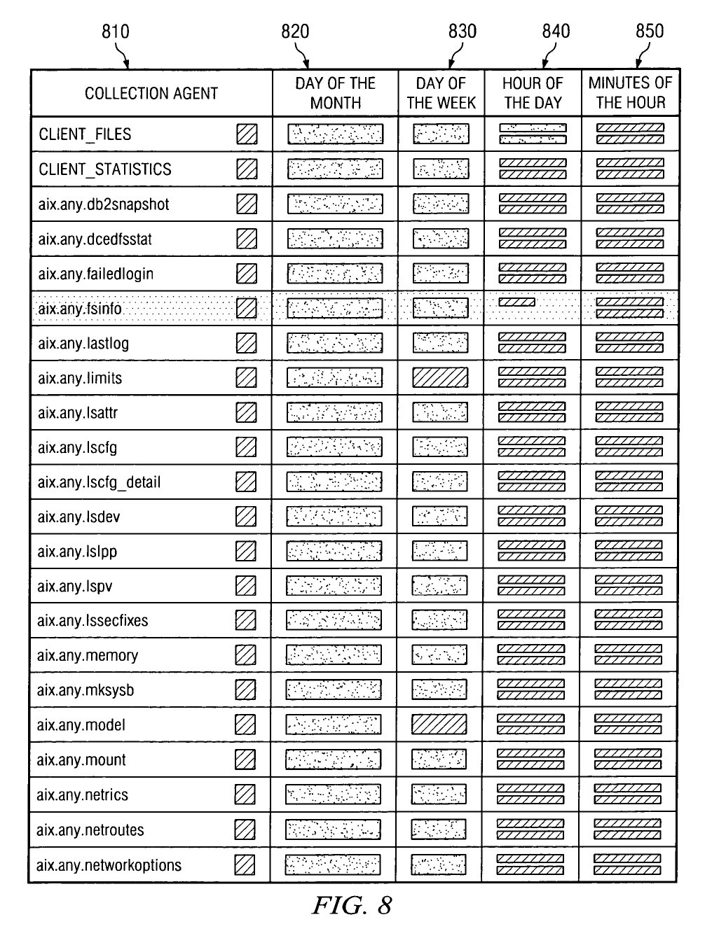

FIG. 8 is an exemplary diagram of a graphical display of schedules for a plurality of task performing resources in accordance with one exemplary embodiment of the present invention. The graphical display illustrated in FIG. 8 may be generated based on the schedule data structures stored in the data storage device for each of the client agents. As shown in FIG. 8, the graphical display includes a listing of client agents 810, e.g., data collection agents, in which a plurality of fields 820-850 are provided for identifying the values of the scheduling parameters selected by the user. Graphical representations of the selected values are provided in each of the fields 820-850 to provide the viewer of the graphical display with an intuitive representation of the scheduling of each of the client agents.

A first field 820 is provided for depicting the selected values for the day of the month scheduling parameter. A second field 830 is provided for depicting the selected values for the day of the week scheduling parameter. A third field 840 is provided for depicting the selected values for the hour of the day scheduling parameter. A fourth field 850 is provided for depicting the selected values for the minutes of the hour scheduling parameter. In each field 820-840 one or more bars are provided that indicate the amount and relative position of the values selected by the user for that scheduling parameter relative to the entire set of possible values for that scheduling parameter. Thus, for example, for the aix.any.fsinfo client agent, the bar that extends from a left hand side of the hour of the day field 840 to approximately the half way point of the field indicates that the hours of 12 a.m. to 6 a.m. have been selected as values for the hour of the day scheduling parameter.

In addition, an indicator is provided of whether or not all of the selected values are to be utilized with a scheduling parameter or a randomly selected value within the selected values is to be utilized with a scheduling parameter. In the depicted example, the indicator is the color of the bars in each field. For example, if a bar is a purple color (depicted as a black bar), then a value from the values represented by that bar is to be randomly selected for use with the scheduling parameter. If a bar is a green color (depicted as a gray bar), then all of the values represented by that bar are to be used with the scheduling parameter. Other types of indicators, e.g., symbols, highlighting, flashing, or the like, may be used without departing from the spirit and scope of the present invention.

With the graphical display of FIG. 8, a plurality of schedules for a plurality of client agents may be displayed at once. Thus, a user may obtain a quick and easily understood representation of the schedules for a plurality of client agents of interest and may be able to quickly determine where changes in client agent schedules are necessary or desirable. As a result, the user need not individually query the scheduling system for the schedules of each client agent and have to create their own “picture” of how the client agents are scheduled relative to each other.

In addition, with the graphical interface provided by the present invention as illustrate din FIG. 8, a user may select an individual client agent in order to obtain additional information regarding the scheduling of the client agent's tasks. For example, a user may select a client agent, e.g., aix.any.fsinfo, in order to bring up a graphical user interface such as that depicted in FIGS. 5-7. The user may then be permitted to view the current schedule parameter values selected for that client agent and even modify those values. The modified values may then be used to update the schedule data structure for that client agent in the data storage device 495 and transmit the updated schedule data structure to the client agent for implementation.

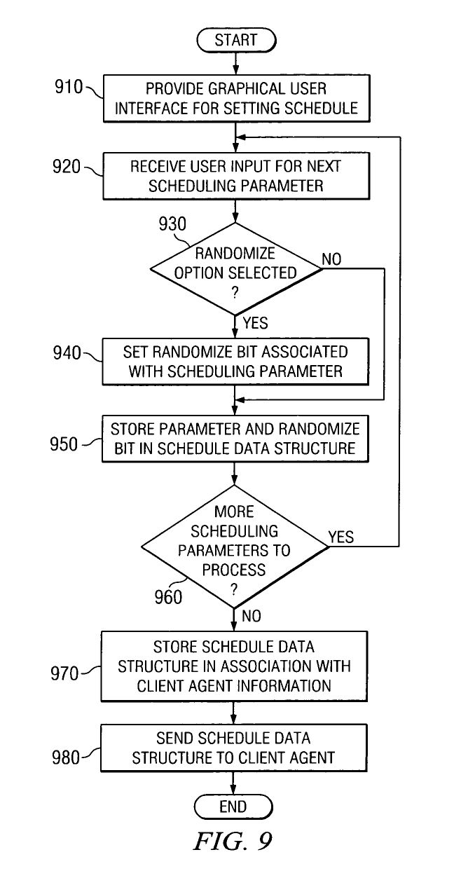

FIG. 9 is a flowchart outlining an exemplary operation of one exemplary embodiment of the present invention when generating a schedule for performance of a task by a client agent. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 9, the operation starts by providing a graphical user interface for setting a schedule associated with a client agent (step 910). User input for a next scheduling parameter is receive via the graphical user interface (step 920). A determination is made as to whether a randomize option is selected for the scheduling parameter (step 930). If so, a randomize bit associated with the scheduling parameter is set (step 940).

Thereafter, or if the randomize option is not selected, the scheduling parameter values and randomize bit are stored in the schedule data structure for the client agent (step 950). A determination is then made as to whether there are more scheduling parameters to process (step 960). If so, the operation returns to step 920 to process the next scheduling parameter. Otherwise, if there are no more scheduling parameters to process, the schedule data structure is stored in association with client agent information in a data storage device (step 970). The schedule data structure is also sent to the client agent (step 980) and the operation terminates.

Thus, the present invention provides a mechanism by which a graphical user interface is provided for a user to designate values for scheduling parameters of a task. In addition, the graphical user interface permits the user to designate a set of values of a scheduling parameter and a randomize option such that a random value from the user selected set of values is used as the value for the scheduling parameter. Moreover, the present invention provides a mechanism for displaying the values of scheduling parameters for one or more client agents such that the values of the scheduling parameters are graphically represented and those scheduling parameters associated with randomly selected values are identified.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for scheduling performance of a task, comprising:
providing a graphical user interface (GUI) having GUI components for entry of two or more scheduling parameters;
receiving user input to the GUI;
generating a schedule data structure for performance of the task based on the received user input to the GUI; and
scheduling performance of the task using the schedule data structure, wherein at least one of the GUI components permits entry of a user selected range of values for a time scheduling parameter at which the task is to be performed on a client computing device, and wherein at least one other GUI components permits selection of a randomize parameter for randomizing an actual value of the time scheduling parameter within the user selected range of values for the time scheduling parameter.

2. The method of claim 1, wherein the GUI components for entry of two or more scheduling parameters includes GUI components for setting a range of values for a plurality of scheduling parameters.

3. The method of claim 2, wherein each range of values for each of the plurality of scheduling parameters is associated with a randomize parameter that may be set by a user of the GUI.

4. The method of claim 1, wherein the method is performed in a server computing device, and wherein the task is a task performed by a client computing device.

5. The method of claim 4, wherein the task is a data collection task of a collection agent running on the client computing device.

6. The method of claim 4, wherein a random value within the user selected range of values for the time scheduling parameter is randomly selected by the client computing device if the randomize parameter has been selected.

7. The method of claim 6, wherein the random value is utilized by the client computing device until the server transmits an update of the schedule data structure to the client computing device.

8. The method of claim 1, wherein the method is implemented in a server, and wherein the method further comprises:
repeating, for each of a plurality of tasks on a plurality of client computing devices, the steps of providing, receiving, generating and scheduling;
transmitting the schedule data structures generated for each of the plurality of tasks to a corresponding client computing device; and
storing the schedule data structures generated for each of the plurality of tasks in a storage device associated with the server.

9. The method of claim 8, further comprising:
generating, based on the stored schedule data structures, a second graphical user interface that provides a display of the values for the scheduling parameters for each of the plurality of tasks on the plurality of client computing devices.

10. The method of claim 9, wherein the graphical user interface has fields for identifying a name of the tasks in the plurality of tasks, a graphical representation of the values selected for each scheduling parameter of each of the schedule data structures generated for each of the plurality of tasks, and an indicator of which scheduling parameters of each of the schedule data structures generated for each of the plurality of tasks has an associated randomize parameter set.

11. A computer program product in a computer readable medium for scheduling performance of a task, comprising:
instructions for providing a graphical user interface (GUI) having GUI components for entry of two or more scheduling parameters;
instructions for receiving user input to the GUI;
instructions for generating a schedule data structure for performance of the task based on the received user input to the GUI; and
instructions for scheduling performance of the task using the schedule data structure, wherein at least one of the GUI components permits entry of a user selected range of values for a time scheduling parameter at which the task is to be performed on a client computing device, and wherein at least one other GUI components permits selection of a randomize parameter for randomizing an actual value of the time scheduling parameter within the user selected range of values for the time scheduling parameter.

12. The computer program product of claim 11, wherein the GUI components for entry of two or more scheduling parameters includes GUI components for setting a range of values for a plurality of scheduling parameters.

13. The computer program product of claim 12, wherein each range of values for each of the plurality of scheduling parameters is associated with a randomize parameter that may be set by a user of the GUI.

14. The computer program product of claim 11, wherein the computer program product is executed in a server computing device, and wherein the task is a task performed by a client computing device.

15. The computer program product of claim 14, wherein the task is a data collection task of a collection agent running on the client computing device.

16. The computer program product of claim 14, wherein a random value within the user selected range of values for the time scheduling parameter is randomly selected by the client computing device if the randomize parameter has been selected.

17. The computer program product of claim 16, wherein the random value is utilized by the client computing device until the server transmits an update of the schedule data structure to the client computing device.

18. The computer program product of claim 11, wherein the computer program product is executed in a server, and wherein the computer program product further comprises:
instructions for repeating, for each of a plurality of tasks on a plurality of client computing devices, execution of the instructions for providing, the instructions for receiving, the instructions for generating and the instructions for scheduling;
instructions for transmitting the schedule data structures generated for each of the plurality of tasks to a corresponding client computing device; and
instructions for storing the schedule data structures generated for each of the plurality of tasks in a storage device associated with the server.

19. The computer program product of claim 18, further comprising:
instructions for generating, based on the stored schedule data structures, a second graphical user interface that provides a display of the values for the scheduling parameters for each of the plurality of tasks on the plurality of client computing devices.

20. A system for scheduling performance of a task, comprising:
a processor;
a display device coupled to the processor; and
a user input device coupled to the processor, wherein the processor provides a graphical user interface (GUI), via the display device, having GUI components for entry of two or more scheduling parameters, receives user input to the GUI via the user input device, generates a schedule data structure for performance of the task based on the received user input to the GUI, and schedules performance of the task using the schedule data structure, wherein at least one of the GUI components permits entry of a user selected range of values for a time scheduling parameter at which the task is to be performed on a client computing device, and wherein at least one other GUI components permits selection of a randomize parameter for randomizing an actual value of the time scheduling parameter within the user selected range of values for the time scheduling parameter.
